(19) United States
(12) Patent Application Publication
(10) Pub. No.: US 2024/0217999 A1
(43) Pub. Date: Jul. 4, 2024

(54) Process for preparing monophosphites

(71) Applicant: Evonik Oxeno GmbH & Co. KG, Marl (DE)

(72) Inventors: Anna Chiara Sale, Recklinghausen (DE); Robert Franke, Marl (DE); Dirk Fridag, Haltern am See (DE); Peter Kucmierczyk, Herne (DE); Ana Markovic, Haltern am See (DE); Armin Börner, Rostock (DE); Jens Holz, Kessin (DE); Kerstin Romeike, Rostock (DE); Gudrun Wenzel, Kessin (DE)

(73) Assignee: Evonik Oxeno GmbH & Co. KG, Marl (DE)

(21) Appl. No.: 18/541,692

(22) Filed: Dec. 15, 2023

(30) Foreign Application Priority Data
Dec. 27, 2022 (EP) 22216771.0

(51) Int. Cl. C07F 9/6524

(52) U.S. Cl. CPC C07F 9/6524

(57) ABSTRACT

Process for preparing monophosphites and the compound used for the preparation.

The invention relates to a method for preparing monophosphites and to the compound used for the preparation.

Monophosphites are classically prepared using Cl-containing compounds or via Cl-containing intermediates.

As described in WO 2015/176929 A1, chlorine residues from the synthesis remain in the organophosphorus compound, which result in problems when using the organophosphorus compounds. For example, the steel of the reactor may be attacked by the chlorine.

Monophosphites prepared using Cl-containing compounds must be laboriously purified after synthesis in order to reduce the Cl content. However, even after laborious purification, Cl residues still remained in the monophosphite, which result in problems with the further use of the compound.

The technical object of the invention is to provide a process in which the problems arising in relation to the prior art are reduced or eliminated.

The object is achieved by a process according to claim 1.

Process comprising the process steps of:
a) initially charging a compound Y, wherein Y is a five-membered ring in which at least one carbon atom has been replaced by a nitrogen atom;
b) adding P(NX₂)₃, where X is —(C₁-C₆)-alkyl;
c) adding a compound according to the formula (I):

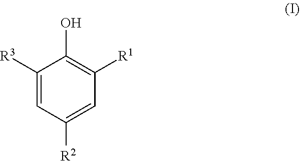

wherein R¹, R², R³ are selected from: —H, —(C₁-C₁₂)-alkyl, —O—(C₁-C₁₂)-alkyl, —(C₆-C₁₀)-aryl, —CN, —NO₂.

Examples of a five-membered ring in which a carbon atom has been replaced by a nitrogen atom are:
pyrrolidine, 2-pyrroline, 3-pyrroline, azole.

Examples of a five-membered ring in which two carbon atoms have been replaced by nitrogen atoms are:
diazolidine, 1,2-diazole, 1,3-diazole.

Examples of a five-membered ring in which three carbon atoms have been replaced by nitrogen atoms are:
1,2,3-triazolidine, 1,2,4-triazolidine, 1,2,3-triazole, 1,2,4-triazole.

Examples of a five-membered ring in which four carbon atoms have been replaced by nitrogen atoms are:
tetrazolidine, 5H-tetrazole, 2,5-dihydro-1H-tetrazole.

An example of a five-membered ring in which five carbon atoms have been replaced by nitrogen atoms is:
1H-pentazole.

In one variant of the process, the five-membered ring (Y) has at least one double bond.

In one variant of the process, the five-membered ring (Y) has two double bonds.

In one variant of the process, the five-membered ring (Y) has at least one N—H bond.

In one variant of the process, the five-membered ring (Y) has at least two nitrogen atoms.

In one variant of the process, the five-membered ring (Y) has at least three nitrogen atoms.

In one variant of the process, the five-membered ring (Y) has four nitrogen atoms.

In one variant of the process, Y is the following compound:

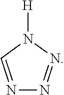

In one variant of the process, X is —(C₁-C₂)-alkyl.

In one variant of the process, X is —CH₃.

In one variant of the process, R¹, R², R³ are selected from: —H, —(C₁-C₁₂)-alkyl, —O—(C₁-C₁₂)-alkyl, —(C₆-C₁₀)-aryl.

In one variant of the process, R¹, R², R³ are selected from: —H, —(C₁-C₁₂)-alkyl, —O—(C₁-C₁₂)-alkyl.

In one variant of the process, R¹, R², R³ are selected from: —H, —(C₁-C₁₂)-alkyl.

In one variant of the process, R¹, R², R³ are selected from: —H, —CH₃, —O—CH₃, -^{tert}Bu.

In one variant of the process, the compound of the formula (I) has the structure (4):

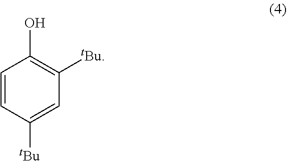 [SMILES: CC(C)(C)c1ccc(O)c(C(C)(C)C)c1]

In one variant of the process, said process comprises the additional process step d) of: d) adding a solvent.

In one variant of the process, the solvent is selected from: acetonitrile (ACN), toluene, xylene, THF, heptane.

In one variant of the process, the solvent is acetonitrile (ACN).

In a variant of the process, the synthesis is carried out in the absence of Cl.

In addition to the process itself, a compound is also claimed, which is used in the process.

Compound according to the formula (3):

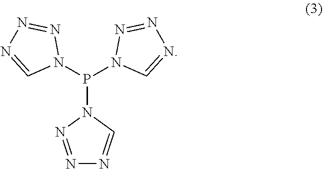 [SMILES: c1nnnn1P(n1cnnn1)n1cnnn1]

The invention is to be illustrated in more detail hereinafter by a working example.

Syntheses of alkanox

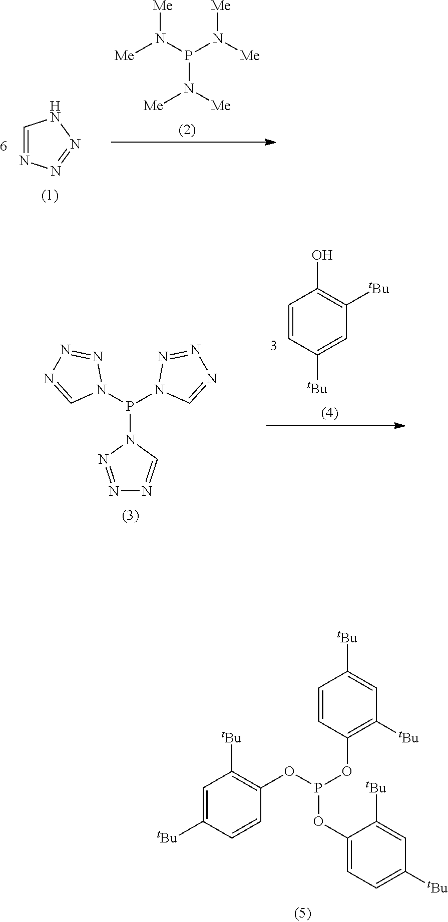 [SMILES: CN(C)P(N(C)C)N(C)C ; c1nnn[nH]1 ; c1nnnn1P(n1cnnn1)n1cnnn1 ; CC(C)(C)c1ccc(O)c(C(C)(C)C)c1 ; CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

To form tri(1H-tetrazo-1-yl)phosphine (3), HMPT (2) (163 mg, 1 mmol) is added to a 0.45M solution of tetrazole (1) in acetonitrile (13.4 ml, 6 mmol) and the mixture is stirred at room temperature under argon for five minutes. Three equivalents of 2,4-di-tert-butylphenol (4) (619 mg, 3 mmol) are then added to the solution. The reaction mixture is now further stirred under argon at 60° C. for about 20 hours. After 15-30 minutes, a white precipitate gradually precipitates from the solution. For work-up, the precipitate is filtered off under anaerobic conditions, washed once with acetonitrile (2 ml) and dried under vacuum.

Yield (5): 0.50 g of white solid (=77%).

³¹P NMR (CD₂Cl₂): 129.9 ppm.

¹H NMR (CD₂Cl₂): 7.40 (3H, d, J 2.5 Hz, 3×Har), 7.40 (3H, dd, J 8.5, 2.1 Hz, 3×Har), 7.12 (3H, dd, J 8.5, 2.5 Hz, 3×Har), 1.41 (27H, s, 3×C(CH₃)₃), 1.30 (27H, s, 3×C(CH₃)₃).

¹³C NMR (CD₂Cl₂): 149.5 (d, J 4.0 Hz, 3×Cₐᵣ—O), 146.2 (3×Cₐᵣ), 139.4 (d, J 2.6 Hz, Cₐᵣ), 125.0 (3×CₐᵣH), 124.0 (3×CₐᵣH), 119.2 (d, J 18.2 Hz, 3×CₐᵣH), 35.4 (3×^{t}C), 34.8 (3×^{t}C), 31.7 (9×CH₃), 30.4 (9×CH₃).

The novel synthetic route makes it possible to dispense with Cl-containing compounds. Firstly, this saves the laborious purification of the monophosphite after synthesis, and secondly the introduction of residual Cl into the reactor is also avoided.

1. Process comprising the process steps of:
a) initially charging a compound Y, wherein Y is a five-membered ring in which at least one carbon atom has been replaced by a nitrogen atom;
b) adding P(NX₂)₃, where X is —(C₁-C₆)-alkyl;
c) adding a compound according to the formula (I): 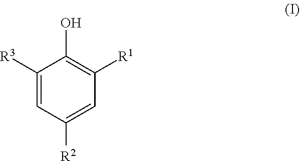
wherein R¹, R², R³ are selected from: —H, —(C₁-C₁₂)-alkyl, —O—(C₁-C₁₂)-alkyl, —(C₆-C₁₀)-aryl, —CN, —NO₂.

2. Process according to claim 1,
wherein the five-membered ring (Y) has at least one double bond.

3. Process according to claim 1,
wherein the five-membered ring (Y) has two double bonds.

4. Process according to claim 1,
wherein the five-membered ring (Y) has at least one N—H bond.

5. Process according to claim 1,
wherein the five-membered ring (Y) has at least two nitrogen atoms.

6. Process according to claim 1,
wherein the five-membered ring (Y) has at least three nitrogen atoms.

7. Process according to claim 1,
wherein the five-membered ring (Y) has four nitrogen atoms.

8. Process according to claim 1,
wherein Y is the following compound:

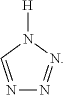

9. Process according to claim 1,
wherein X is —(C₁-C₂)-alkyl.

10. Process according to claim 1,
wherein X is —CH₃.

11. Process according to claim 1,
wherein R¹, R², R³ are selected from: —H, —(C₁-C₁₂)-alkyl, —O—(C₁-C₁₂)-alkyl, —(C₆-C₁₀)-aryl.

12. Process according to claim 1,
wherein R¹, R², R³ are selected from: —H, —(C₁-C₁₂)-alkyl, —O—(C₁-C₁₂)-alkyl.

13. Process according to claim 1,
comprising the additional process step d) of:
d) adding a solvent.

14. Process according to claim 13,
wherein the solvent is selected from: acetonitrile (ACN), toluene, xylene, THF, heptane.

15. Compound according to the formula (3): 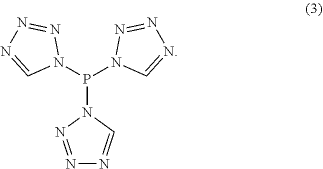 [SMILES: c1nnnn1P(n1cnnn1)n1cnnn1]
